(19) United States
(12) Patent Application Publication
(10) Pub. No.: US 2021/0381682 A1
(43) Pub. Date: Dec. 9, 2021

(54) LUMINAIRE CONNECTION AND LUMINAIRE STRIP

(71) Applicant: WIELAND ELECTRIC GMBH, Bamberg (DE)

(72) Inventors: Volker HENNEMANN, Scheßlitz (DE); Jürgen WINKLER, Gundelsheim (DE); Jonathan LÖSEL, Baunach-Priegendorf (DE); Frank BAUER, Staffelbach (DE); Anatoli BOLT, Heiligenhaus (DE)

(73) Assignee: WIELAND ELECTRIC GMBH, Bamberg (DE)

(21) Appl. No.: 17/277,888

(22) PCT Filed: Sep. 27, 2019
(86) PCT No.: PCT/EP2019/076182

§ 371 Date: Mar. 19, 2021

(30) Foreign Application Priority Data
Sep. 28, 2018 (DE) 20 2018 105 607.7

(51) Int. Cl. F21V 23/06; F21V 21/02

(52) U.S. Cl. CPC F21V 23/06; F21V 17/104; F21V 21/025

(57) ABSTRACT

Luminaire connector for a luminaire strip composed of at least two luminaire elements connected in series and arranged on or in a room ceiling with feed contacts (2) for feeding electrical potential from an electrical building supply network into the luminaire strip, having two electrical connection contacts (5) in such a way that a bulbar (6) electrically supplying the luminaire element assigned to it is connected to each connection contact (5), and with at least one receiving means (15) for a mechanical coupling part (15) bearing the luminaire elements against one another.

The present invention relates to a luminaire strip composed of a plurality of luminaire elements and a luminaire connector as a core element thereof. Such luminaire strips are installed in buildings, for example. In such cases, the luminaire strips are either recessed into a ceiling or suspended ceiling constructions or suspended from a ceiling of a building. The luminaire strip has a modular design. Individual luminaire elements are connected in series and assembled to form the luminaire strip. In a luminaire strip, gaps can be left between the individual luminaire elements or luminaire elements can be placed next to each other to create a continuous luminaire strip. The present invention relates to the latter.

Usually, the individual luminaire elements are prefabricated at the luminaire manufacturer's premises and then delivered to the construction site, where they are assembled to form the luminaire strip and simultaneously mounted on or in the building ceiling. Starting from the prefabricated luminaire element, mechanical and electrical problems have to be solved during assembly. Electrical problems are feeding the electric current or potential from the building's supply network into the luminaire strip, passing the electric potential through the luminaire strip, and supplying electric current to the luminaire elements. On the mechanical side, the luminaire elements have to be connected to each other to form a chain or strip, and they also have to be attached to the ceiling of the building.

Based on this, the invention is based on the task of designing a luminaire strip and a luminaire connector in such a way that the assembly of the luminaire strip can be carried out easily and that the final assembled luminaire strip has a high level of operational safety.

This task is solved in an inventive manner by the combination of features of claims 1 and 16. The related claims include further developments of these two basic inventions, some of which are advantageous and some of which are inventive in themselves.

The core of the luminaire strip according to the invention is a luminaire connector that solves both mechanical and electrical tasks, i.e. a multi-functional luminaire connector. On the one hand, this luminaire connector has feed contacts for feeding the electrical potential from the electrical supply network of the building. On the other hand, at least two connection contacts are provided in order to be able to supply two luminaire elements electrically with one connection. In the luminaire elements, busbars are provided for electrical supply. These busbars are suitably designed such that electrical potential can be tapped from the busbar by means of a tap in order to conduct this electrical potential to the luminaire. The use of the busbar has the great advantage that the tap can be moved along the busbar until the optimum tap position is found. The busbar is designed in such a way that the largest possible area is suitable for mounting a tap.

Finally, the luminaire connector designed in this way is combined with a receiving means for a mechanical coupling part. The mechanical coupling part is used to bear or fasten the individual luminaire elements to each other. Via the receiving means, the luminaire connector also forms the support for the mechanical coupling part or parts, as it were.

In further development of the invention, the luminaire connector body is constructed in the manner of a T. From the horizontally running T-cross yoke, feed contacts protrude upwards, i.e. vertically oriented feed contacts. The feed contacts are used to feed the electrical potential provided by the building supply network into the luminaire element. Advantageously, the building supply network is provided with feed connectors at the ends. which can be easily plugged onto the feed contacts. The feed contacts can be designed in the form of contact lugs and project vertically upwards from the horizontal T-cross yoke.

In addition, two connection contacts facing away from each other are formed on the sides of the vertical T-leg. The two connection contacts run at right angles to the feed contacts. The connection contacts in turn interact with corresponding mating contacts on one busbar each.

When looking at the luminaire connector from above, it has a rectangular cross-sectional shape in a further advantageous embodiment. On the luminaire connector body, two opposite long sides are designed to receive the connection contacts, while the two short rectangular sides are designed as receiving means for one coupling part each. Looking at the luminaire connector body from the side, it is advantageous to arrange the connection contacts in a first plane and the receiving means for the coupling parts in a second plane below.

In an advantageous further development of the invention, the connection contacts are C-shaped. The C-shape creates such a mouth-shaped outline of the connection contacts that each connection contact is suitable to overlap the peripheral edge of the busbar supplied by it with electrical potential in the manner of an open mouth. In this way, the busbars are both electrically connected to the luminaire connector and positively secured in its connection contacts with their peripheral edges.

In a further embodiment, it is proposed that the connection contacts on the luminaire connector and the corresponding mating contacts on the busbar be designed in the manner of plug connections, namely with contact pins on one part and female contacts on the other part. In a preferred safety variant, the connection contacts on the luminaire connector are designed as female contacts and the corresponding mating contacts on the busbar as pin contacts. This has the advantage that female contacts are usually well protected against touch contact. Since the female contacts on the connection contacts of the luminaire connector in the invention are the current-carrying parts that introduce the current provided by the electrical building supply network into the busbar, the busbar does not become live until its mating contacts are connected to the connection contacts.

This configuration of the connection contacts and the mating contacts is further optimized by a touch protection adapted to a free end of the busbar. The touch protection is designed in such a way that the pin contacts formed on the contact rail cannot be touched, but it is nevertheless possible to insert the pin contacts into the female contacts of connection contacts of a luminaire connector to be connected when the touch protection is fitted.

With this touch protection it is possible to realize an assembly consisting of a luminaire connector or a luminaire connector body, a busbar plugged to the luminaire connector body with the connectors and with a touch protection at the end. This assembly can either be further installed in a housing of a luminaire element and electrically contacted after installation, i.e. connected to the building supply network via the feed contacts of the luminaire connector. It is even possible to connect the assembly to the building supply network without a housing, without being able to touch the pin contacts protruding from the busbar at the free end facing away from the luminaire connector. Although the pin contacts are connected to the electrical potential of the building supply network, i.e. they are “live”, the contact protection prevents injuries or other damage.

Another improvement measure relates to a particularly advantageous configuration of the busbar. The latter has thus several copper conductors running parallel to each other. These copper conductors are separated from each other by intermediate separators. The short-circuit risk is thus eliminated. It is particularly advantageous to configure the busbar in such a way that U-shaped receiving chambers for the individual copper conductors are formed on the underside of a plate-shaped busbar base body. The U-shaped receiving chambers adequately shield the copper conductors from each other and also protect them from touch. Nevertheless, the open side of the U allows a contact to reach into or be inserted into the U-shaped receiving chamber to contact the copper conductors and thus to tap potential from the copper conductors.

In another advantageous configuration, a tap compressed into an integral component is provided. This may be a block or the like on which several touch contacts are arranged to tap the potential for the luminaires from the copper conductors in the desired manner. In a particularly advantageous embodiment, these touch contacts are spring-mounted. They simply have to engage in the U-shaped receiving chambers and touch the copper conductors assigned to them in each case. The springing prevents excessive contact pressure from being exerted by the touch contact on the copper conductor.

Finally, a last further development relates to the coupling part. Here, it is simple in terms of production and favorable in terms of installation to adapt a bracket to the receiving means at the luminaire connector. The coupling parts are thus formed in a bracket-like manner. Connecting metal sheets or shaped metal sheets can serve as brackets, for example. Advantageously, the housings of the luminaire elements and the brackets or shaped metal sheets are matched to each other in such a way that the brackets or shaped metal sheets can be inserted into pockets, guides or similar recesses in the area of the housing wall of the housing of the luminaire element in order to secure the individual luminaire elements to each other in a form-fitting manner. The interface between the receiving means and the coupling part is advantageously designed as a tongue-and-groove connection, i.e. again as a positive connection.

Taken together, these measures make it possible to create a two-part housing for each luminaire element. This housing consists of a hood essentially in the shape of an upside-down U and a bottom part. The luminaire connector is then located in the hood in the area of the horizontal U-ground or U-cross yoke. The luminaire connector, with its feed contacts oriented upwards, reaches through the hood in a corresponding recess. In this way, the feed contacts can be connected to the feed connectors of the building supply network. Furthermore, a busbar already pre-mounted and pre-contacted on the luminaire connector runs horizontally below the U-cross yoke, wherein the free end of the busbar with the touch protection protrudes from the hood of the housing at the end. In the area of the inner surfaces of the U-legs, the bracket-like coupling parts, preferably in the form of shaped metal sheets, are arranged and connected to the luminaire connector via the receiving means. The free ends of the coupling parts, which are designed as brackets, protrude from the end side of the hood facing away from the touch protection. This arrangement makes it possible to adapt a suitably designed second hood pre-assembled with a busbar to the first hood. This second hood is pushed with its free end with the grip protection over the brackets at the free end of the first-mentioned hood. The brackets engage the inner surfaces of the side walls of the second hood and thus serve as a coupling part between the two luminaire elements. The luminaire elements are pushed together until the grip protection with the embedded pin contacts engage in the female contacts at the free connection contact of the first-mentioned hood. In this way, by stringing together any number of luminaire elements, the luminaire strip according to the invention can be realized.

To complete the luminaire strip, the aforementioned hood is placed on the bottom part or the bottom part is snapped onto the hood. The bottom part is also U-shaped. A block-shaped tap with touch contacts for tapping electrical potential from the copper conductors of the busbar rests on the U-cross yoke of the bottom part. The block with the tap is positioned in the bottom part in such a way that the tap is brought into the desired relative position of the touch contacts to the copper conductors. In this way, the touch contacts can contact the copper conductors at the desired location. It is also possible to accommodate other parts in the bottom part, for example an emergency power supply or other devices. Typically, the bottom is also a U-profile closed along the length of the luminaire strip, wherein the free ends of the U-legs of the bottom-side U-profile can be latched to the free ends of the U-legs of the hood. The illuminants are positioned on the underside of the bottom or below the bottom. The invention is explained in more detail with reference to the exemplary embodiments shown in the drawings. They show the following:

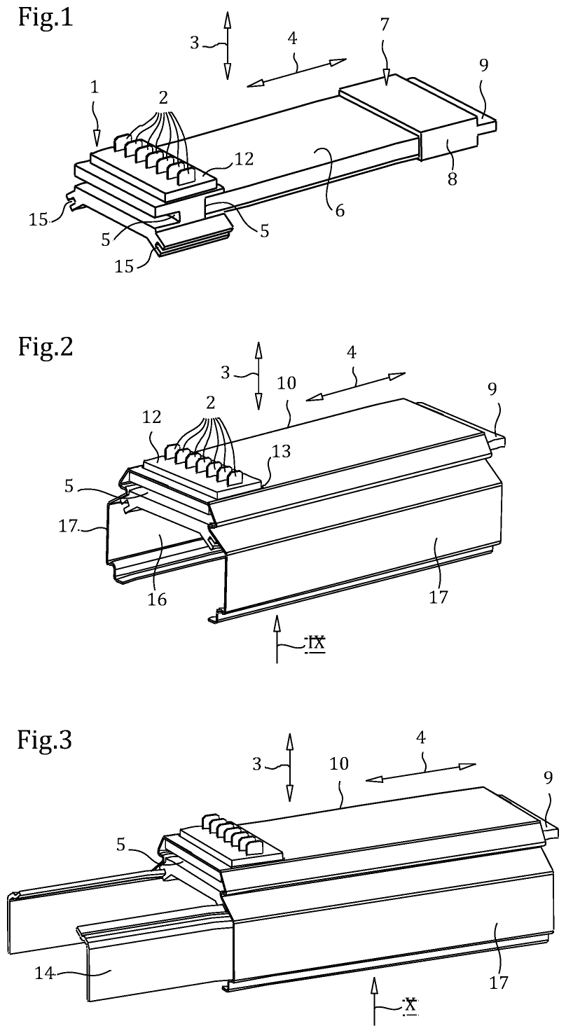

FIG. 1 an assembly composed of a luminaire connector body, a busbar and touch protection,

FIG. 2 the assembly of FIG. 1 inserted into a hood of a luminaire element housing,

FIG. 3 the housing hood assembly shown in FIG. 2 with additionally adapted coupling parts,

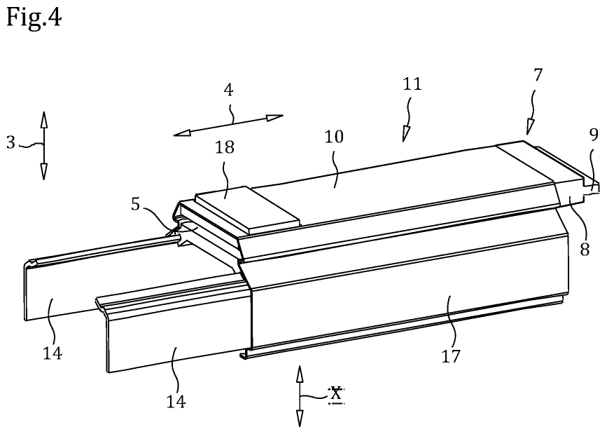

FIG. 4 an alternative embodiment of the assembly shown in FIG. 3,

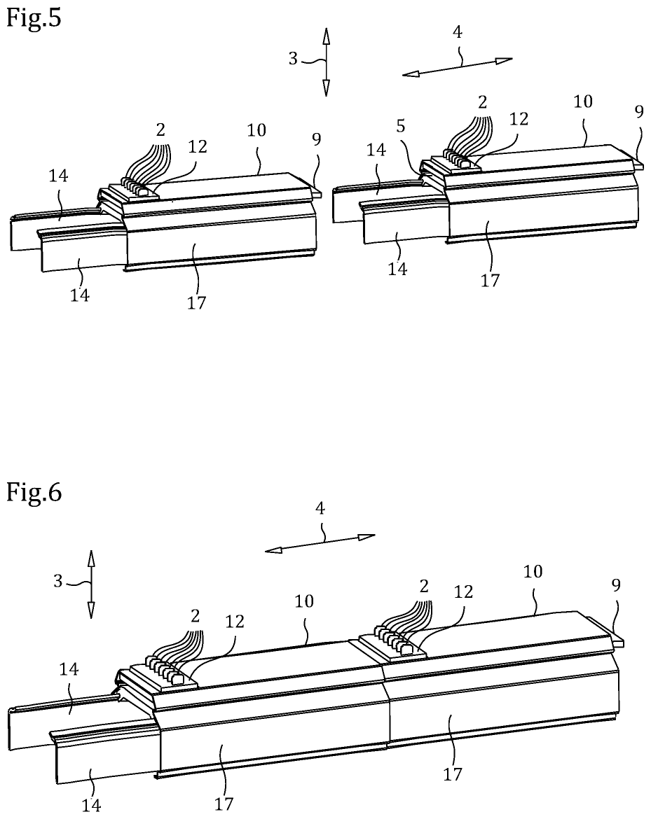

FIG. 5 two assemblies from FIG. 3 to be assembled together to form a luminaire strip,

FIG. 6 the luminaire elements from FIG. 5 in the assembled state,

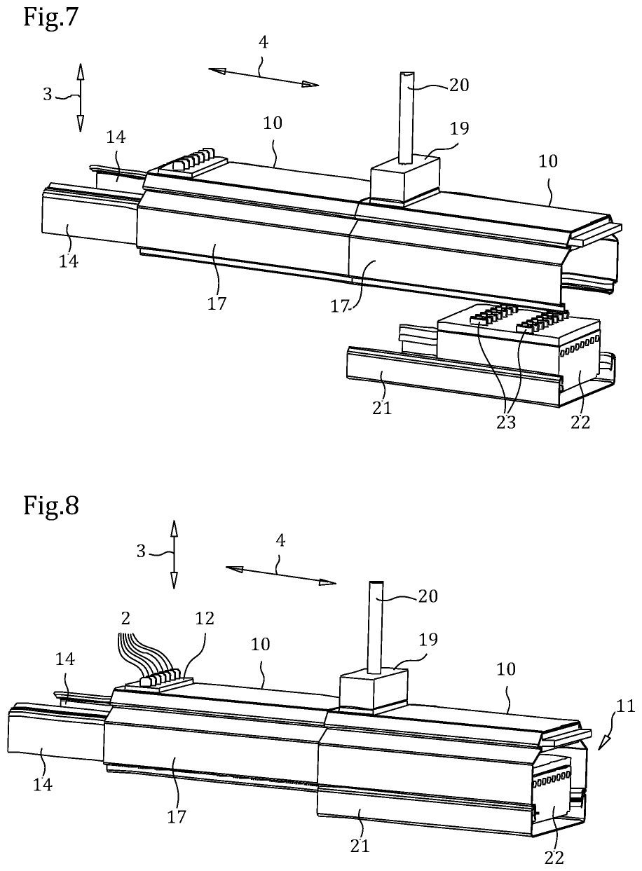

FIG. 7 the assembly of FIG. 6 with a feed connector of the electrical building supply system pushed onto the feed contacts and a bottom part with a tap adapted thereto and configured as a block,

FIG. 8 the components shown in FIG. 7 in the final assembly state, FIG. 9 a bottom view of the assembly shown in FIG. 2 according to visual arrow IX in FIG. 2,

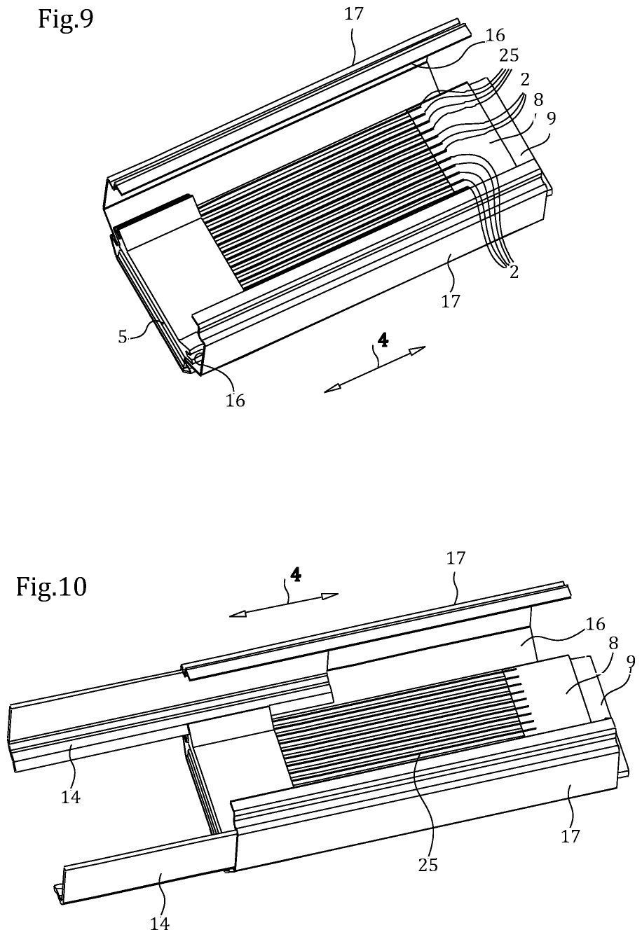

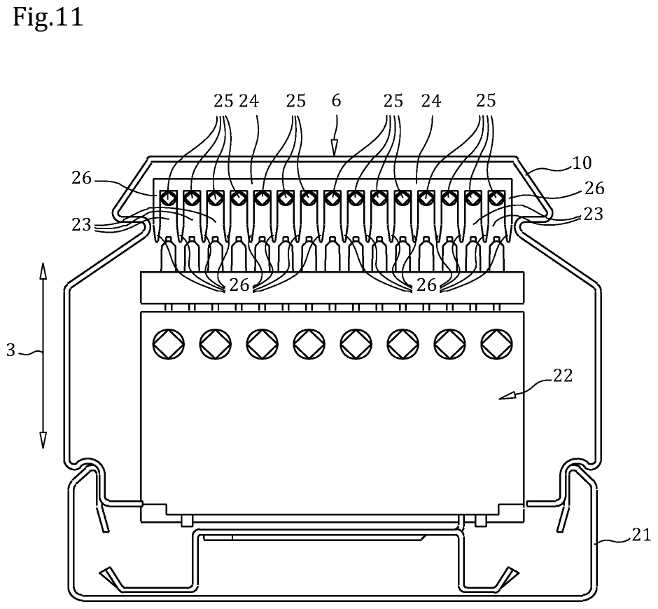

FIG. 10 a bottom view of the assembly shown in FIG. 3 according to visual arrow X in FIG. 3,

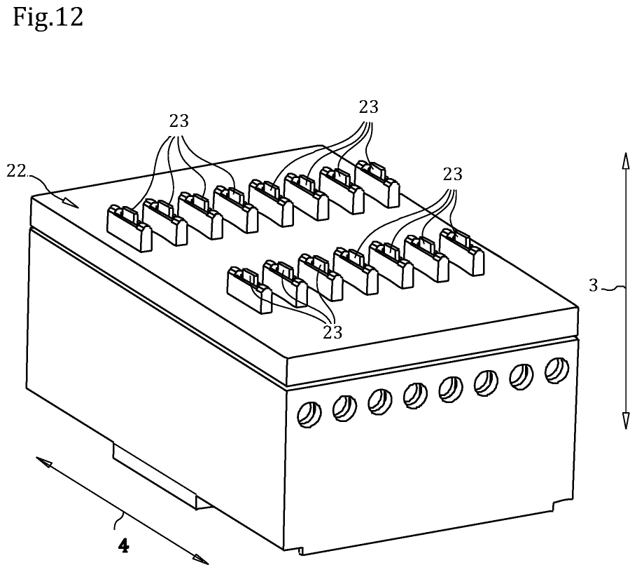

FIG. 11 a section through the closed housing of the luminaire strip shown in FIG. 8, and

FIG. 12 a tap configured as a block.

The luminaire connector body 1 shown on the left in FIG. 1 firstly has feed contacts 2. The feed contacts 2 protrude vertically upwards from the luminaire connector body 1 in the vertical direction 3. In the horizontal direction 4 perpendicular to the vertical direction 3, two C-shaped connection contacts 5 are oriented on the luminaire connector body 1. The C-shaped connection contacts 5 pointing in the horizontal direction 4 are mouth-shaped and thus embrace a peripheral edge of the busbar 6 extending in the horizontal direction 4. The busbar 6 carries a touch protection 7 at its free end facing away from the luminaire connector body 1 in horizontal direction 4. The touch protection 7 has a cuboid housing body 8 which surrounds the free end of the busbar 6 and a contact strip 9 which adjoins the housing body 8 in the horizontal direction 4. The contact strip 9 consists of a touch protection 7 visible in FIG. 1 and individual pin contacts arranged in the touch protection 7, which are not visible in FIG. 1.

In the depiction of FIG. 2, the luminaire connector busbar touch protection assembly shown in FIG. 1 is installed in the hood 10 of a luminaire element housing 11. The rectangle-shaped contact carrier 12, which carries the feed contacts 2, passes through the hood 10 in a rectangle-shaped hood opening 13. Furthermore, the touch protection 7 is latched with a housing body 8 in the inner contour of the hood 10 and the contact strip 9 of the touch protection 7 protrudes in horizontal direction 4 from the hood 10 and thus from the luminaire element housing 11. FIG. 9 shows the bottom view of the same assembly.

In FIG. 3 and FIG. 10, the mechanical coupling parts 14 designed as brackets are visible. The coupling parts 14 protrude from the end of the hood 10 facing away from the contact strip 9 of the touch protection 7 in the horizontal direction 4, and thus from the luminaire element housing 11. The coupling parts 14 are inserted into the receiving means 15 arranged on the luminaire connector body 1. The receiving means 15 are formed as a groove. The coupling parts 14 are inserted into these grooves on the receiving means 15 as tongues to form a tongue-and-groove connection. Furthermore, the coupling parts 14 are positively guided in guides 16 on the inner sides of the side walls 17 of the hood 10.

FIG. 4 shows a modified version of the assembly shown in FIG. 3, with only the differences being discussed below. In the assembly shown in FIG. 4, the feed contacts 2 are deactivated by placing a deactivation hood 18 over the feed contacts 2 and the contact carrier 12. Furthermore, in the embodiment shown in FIG. 4, the touch protection 7 protrudes from the luminaire element housing 11 in the horizontal direction 4 both with part of its housing body 8 and with its contact strip 9.

In the depiction of FIG. 5, two hoods 10 pre-assembled according to FIG. 3 are placed one behind the other in the horizontal direction 4. If the hood 10 depicted on the right in FIG. 5 is pushed in the horizontal direction 4 into the hood 10 depicted on the left in FIG. 5, the contact strip 9 of the left assembly finally engages in the connection contact 5 of the right assembly. The coupling parts 14 engage in the guides 16 on the inner sides of the side walls 17 of the left hood 10, so that both assemblies are pushed together to form the luminaire strip depicted in FIG. 6.

To connect the luminaire connector to the electrical supply network of the building, the feed connector 19 is plugged onto the feed contacts 2. The feed connector 19 is connected at the rear to the mains line 20 of the building supply network. In this way, electrical potential from the building supply network is introduced into the luminaire connector.

Furthermore, FIG. 7 shows the housing bottom 21 acting as a device carrier. The housing bottom 21 is latched to the hood 10 in the final assembly position shown in FIG. 8. Mounted on the housing bottom 21 is the tap block 22 shown in detail in FIG. 12. The tap block 22 carries spring-loaded touch contacts 23 on its upper side.

FIG. 11 shows the interaction of the busbar 6 and the tap block 22. The busbar 6 consists of an extruded profile which forms a plate-shaped busbar base body 24. U-shaped receiving chambers for copper conductors 25 arranged side by side and running parallel in the horizontal direction 4 are arranged on the underside of the busbar base body 24. The receiving chambers for the copper conductors 25 are open at the bottom so that the spring-loaded touch contacts 23 on the tap block 22 can engage in the receiving chambers from below in the vertical direction 3 and make direct contact with the copper conductors 25.

### LIST OF REFERENCE SIGNS

1 Luminaire connector body
2 Feed contact
3 Vertical direction
4 Horizontal direction
5 Connection contact
6 Busbar
7 Touch protection
8 Housing body
9 Contact strip
10 Hood
11 Luminaire element housing
12 Contact carrier
13 Hood opening
14 Coupling part
15 Receiving means
16 Guide
17 Side wall
18 Deactivating hood
19 Feed connector
20 Mains line
21 Housing bottom
22 Tap block
23 Touch contact
24 Busbar base body
25 Copper conductor
26 Separator

1. Luminaire connector for a luminaire strip composed of at least two luminaire elements connected in series and arranged on or in a room ceiling, the luminaire connector comprising:
feed contacts for feeding electrical potential from an electrical building supply network into the luminaire strip,
two electrical connection contacts in such a way that a busbar electrically supplying the luminaire element assigned to it is connected to each connection contact, and
having at least one receiving means for a mechanical coupling part bearing the luminaire elements against one another.

2. Luminaire connector according to claim 1, further comprising a luminaire connector body having said feed contacts oriented vertically upwards and said connection contacts oriented horizontally at right angles to the feed contacts.

3. Luminaire connector according to claim 2, wherein
a rectangular cross-sectional shape of the luminaire connector body having two connection contacts opposite each other on the rectangular long sides and having two further receiving means opposite each other for a coupling part on each of the rectangular short sides.

4. Luminaire connector according to claim 1, wherein said connection contacts which are C-shaped in cross-section and surround the edges of the busbar in the manner of a mouth.

5. Luminaire connector according to claim 1, further comprising female contacts or contact pins as connection contacts and by correspondingly complementary designed, plug-in compatible pin contacts or female contacts as mating contacts on the busbar.

6. Luminaire connector according to claim 5, wherein said female contacts as connection contacts and by pin contacts of complementary design and plug-in are compatible with the female contacts as mating contacts on the busbar.

7. Luminaire connector according to claim 6, further comprising a touch protection adaptable at one end of the busbar for its pin contacts in such a way that the pin contacts can still be inserted into the female contacts of a connection contact of an adjacent luminaire connector when the touch protection is adapted.

8. Luminaire connector according to claim 1, wherein said busbar comprises a plurality of copper conductors running parallel to one another and separated from one another in each case by separators.

9. Luminaire connector according to claim 8, wherein the busbar has a plate-shaped busbar base body with downwardly projecting separators running parallel to one another in such a way that two separators arranged next to one another and the region of the busbar base body connecting them at their upper fixed end form a U-shaped receiving chamber for a copper conductor in each case.

10. Luminaire connector according to claim 8, wherein the copper conductors are adapted to be open and freely accessible on the underside of the busbar.

11. Luminaire connector according to claim 1, further comprising a tap or tap block adaptable to the underside of the busbar with touch contacts abutting the copper conductors in the final assembled state and with further connection contacts to the illuminant.

12. Luminaire connector according to claim 11, further comprising spring-mounted touch contacts.

13. Luminaire connector according to claim 1, further comprising a bracket bridging two adjacent luminaire element housings as a coupling part.

14. Luminaire connector according to claim 13, further comprising a receiving means configured as a groove into which a tongue is inserted as a spring to form a tongue-and-groove connection between the receiving means and the coupling part.

15. Luminaire connector according to claim 13, further comprising a respective guide on an inside of the housing side walls of a luminaire element housing, into which, in the case of two luminaire elements fixed next to one another, a respective coupling part bridging the two luminaire elements is inserted.

16. Luminaire, strip composed of a plurality of luminaire elements, having at least one luminaire connector according to claim 1.
